(19) United States
(12) Patent Application Publication
(10) Pub. No.: US 2025/0279742 A1
(43) Pub. Date: Sep. 4, 2025

(54) MOTOR DRIVE SYSTEM

(71) Applicant: TOYOTA JIDOSHA KABUSHIKI KAISHA, Toyota-shi (JP)

(72) Inventor: Hajime KOSUGI, Okazaki-shi (JP)

(73) Assignee: TOYOTA JIDOSHA KABUSHIKI KAISHA, Toyota-shi (JP)

(21) Appl. No.: 19/039,136

(22) Filed: Jan. 28, 2025

(30) Foreign Application Priority Data
Feb. 29, 2024 (JP) 2024-030374

(51) Int. Cl. H02P 29/028; H02P 25/22

(52) U.S. Cl. CPC H02P 29/028; H02P 25/22

(57) ABSTRACT

A motor drive system includes: a motor; a first inverter including a plurality of switching elements corresponding to windings of the motor, a second inverter including a plurality of switching elements corresponding to the windings of the motor, a current capacity of the second inverter being less than a current capacity of the first inverter; and a processor for controlling the first inverter and the second inverter. Further, the processor, when a motor lock occurs to the motor, distributes current to two arms other than a current concentrated phase of the first inverter through the motor.

### CROSS-REFERENCE TO RELATED APPLICATION(S)

The present application claims priority to and incorporates by reference the entire contents of Japanese Patent Application No. 2024-030374 filed in Japan on Feb. 29, 2024.

### BACKGROUND

The present disclosure relates to a motor drive system.

Japanese Laid-open Patent Publication No. 2020-134990 discloses a technique for preventing overheating of the power converter of the inverter by reducing the switching frequency of the switching element when the motor lock. In this technology, the switching frequency is switched based on the temperature and torque command value of the inverter at the time of determination of the motor lock.

### SUMMARY

There is a need for providing a motor drive system capable of reducing the surge voltage to the switching element.

According to an embodiment, a motor drive system includes: a motor; a first inverter including a plurality of switching elements corresponding to windings of the motor, a second inverter including a plurality of switching elements corresponding to the windings of the motor, a current capacity of the second inverter being less than a current capacity of the first inverter; and a processor for controlling the first inverter and the second inverter. Further, the processor, when a motor lock occurs to the motor, distributes current to two arms other than a current concentrated phase of the first inverter through the motor.

### BRIEF DESCRIPTION OF THE DRAWINGS

FIG. 1 is a schematic circuit diagram illustrating an example of a motor drive system using a dual inverter according to an embodiment;

FIG. 2 is a flowchart illustrating an outline of a process performed by the motor drive system according to an embodiment;

FIG. 3 is a circuit diagram of a motor drive system in a dual inverter mode at a time of high torque of the motor drive system according to an embodiment;

FIG. 4 is a diagram illustrating a relationship between each current value and time in each phase of the motor drive system according to an embodiment; and

FIG. 5 is a schematic circuit diagram of a motor driving system in a single inverter mode of the motor driving system according to an embodiment.

### DETAILED DESCRIPTION

In the technique disclosed in Japanese Laid-open Patent Publication No. 2020-134990, when the motor locks and a surge voltage to the switching element is increased, there is a possibility that the switching element is damaged.

Hereinafter, a motor drive system using a dual inverter according to an embodiment of the present disclosure will be described with reference to the drawings. Note that the components in the following embodiments include those which can be substituted and easily by those skilled in the art, or those which are substantially the same. Further, the drawings referred to in the following description are only schematically illustrating the shape, size, and positional relationship to the extent that the contents of the present disclosure can be understood. In other words, the present disclosure is not limited only to the shape, size, and positional relationship exemplified in each of the figures.

### Configuration of the Motor Drive System

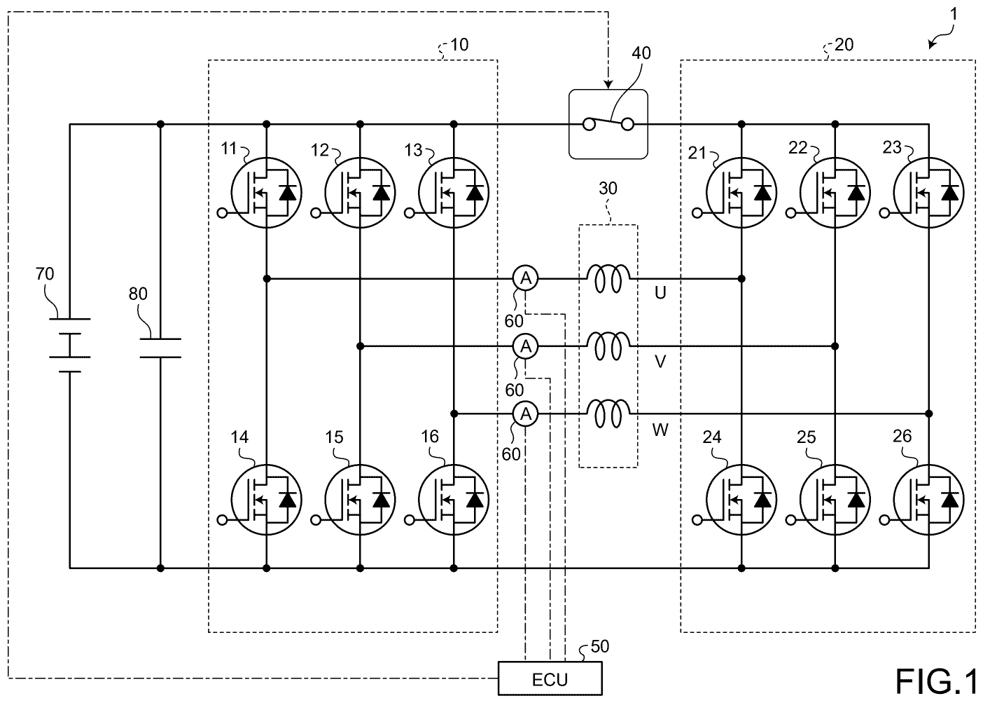

FIG. 1 is a schematic circuit diagram illustrating an example of a motor drive system using a dual inverter according to an embodiment. The motor drive system 1 in FIG. 1 is mounted on an Electric Vehicle (EV). The motor drive system 1 is a system in which two independent first inverters 10 and second inverters 20 are electrically connected to a three-phase (U-phase, V-phase and W-phase) open winding motor 30 and drives the open winding motor 30 by a first inverter 10 and a second inverter 20.

The motor drive system 1 further includes a switch 40 for driving only the first inverter 10 of at least the first inverter 10 and the second inverter 20 and an Electronic Control Unit (ECU) 50 for controlling the switch 40. Furthermore, the motor drive system 1, an ammeter 60 is provided in each path of each of the three phases, the detected results of each ammeter 60 (current value Iu, current value Iv, current value Iw) are outputted to the ECU 50. Further, the first inverter 10, a battery 70 and a smoothing capacitor 80 is electrically connected.

The first inverter 10 is constituted by six power elements 11 to 16, under the control of the ECU 50, repeats the on-off operation. The second inverter 20 is composed of six power elements 21 to 26, under the control of the ECU 50, repeats the on-off operation. The first inverter 10 and the second inverter 20 provide AC power to the open winding motor 30 under the control of the ECU 50. Furthermore, the power elements 11 to 16 of the first inverter 10, as compared with the power elements 21 to 26 of the second inverter 20, the current capacity is formed larger. In one embodiment, the power elements 11 to 16 and 21 to 26 function as switching elements.

The Switch 40 is electrically connectable to the first inverter 10 and the second inverter 20, and under the control of the ECU 50 and becomes an on-state or an off-state (open-state).

The ECU 50 is implemented using memories and a processor with hardware. The hardware may be, for example, memories, a Central Processing Unit (CPU), a Digital Signal Processor (DSP) and a Field-Programmable Gate Array (FPGA). In a case where a motor locking in the open winding motor 30 occurs, the ECU 50 distributes current to two arms other than a current concentration phase of the first inverter 10 through the open winding motor 30. Specifically, when the motor locking to the open winding motor 30 occurs, the ECU 50 sets the switch 40 to the off state (open state), and distributes and supplies current to the two arms other than the current concentration phase of the first inverter 10 trough the open winding motor 30. In one embodiment, the ECU 50 functions as a processor.

### Processing of the Motor Drive System

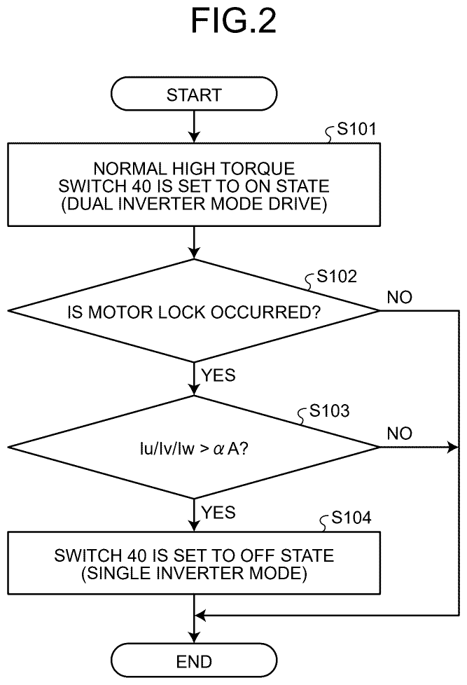

Next, a process that the motor driving system 1 executes is described. FIG. 2 is a flowchart illustrating an outline of a process that the motor drive system 1 executes.

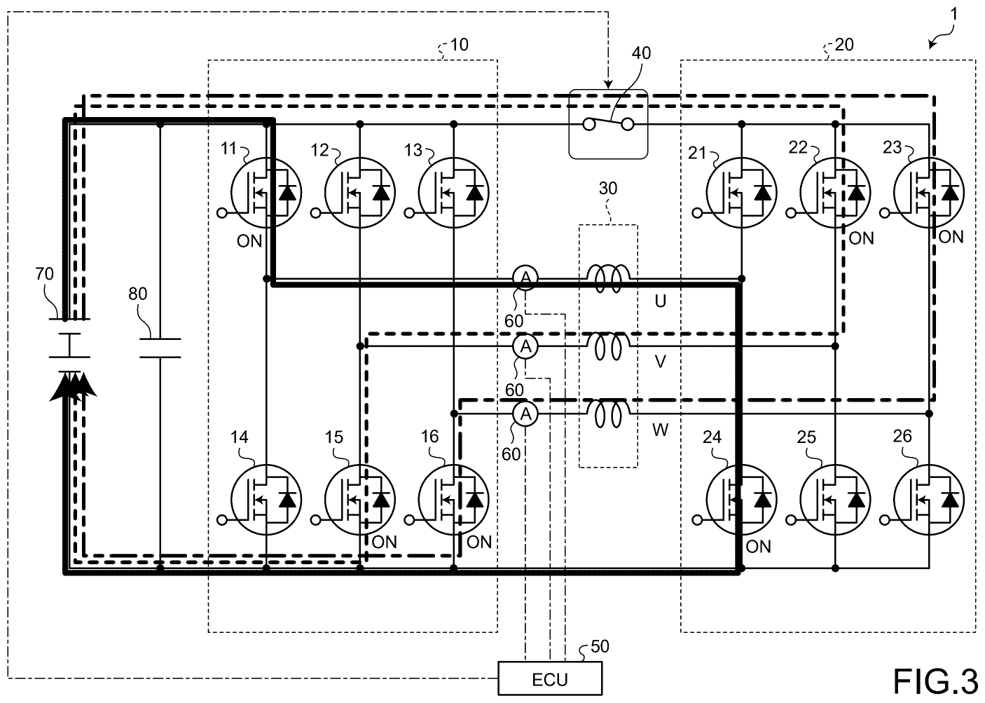

As illustrated in FIG. 2, in a state of high torque where normal high torque is required for the open winding motor 30, the ECU 50 turns on the switch 40 to drive in a dual inverter mode where both the first inverter 10 and the second inverter 20 operate (step S101). FIG. 3 is a circuit schematic diagram of the motor drive system 1 in the dual inverter mode at the time of high torque. As illustrated in FIG. 3, the ECU 50 drives the open winding motor 30 by the first inverter 10 and the second inverter 20 by turning on the switch 40 (dual inverter mode drive). In this case, as illustrated in FIG. 3, the ECU 50 turns on the power elements 11, 15, and 16 of the first inverter 10 to set an On Duty state (ON_Duty state), and turns on the power elements 22, 23, and 24 of the second inverter 20 to set the On Duty state (ON_Duty state). As a result, the ECU 50 drives under the dual inverter mode in which a current on the U-phase becomes the highest among the three phases of the U-phase, V-phase, and W-phase.

Subsequently, the ECU 50 determines whether a motor-lock has occurred in the open winding motor 30 based on the detected result of each of the ammeters 60 (step S102). Specifically, the ECU 50 determines whether the current values Iu, Iv, and Iw of the U-phase, V-phase, and W-phase, respectively, of the three-phases detected by the ammeters 60 are constant with a constant value. When determining that those values are constant with the constant value, the ECU 50 determines that the motor locking occurs in the open winding motor 30. If the motor locking to the open winding motor 30 has occurred (Yes in step S102), the ECU 50 proceeds to step S103. In contrast, when the ECU 50 determines that the motor locking to the open winding motor 30 does not occur (No in step S102), the motor drive system 1 ends the process.

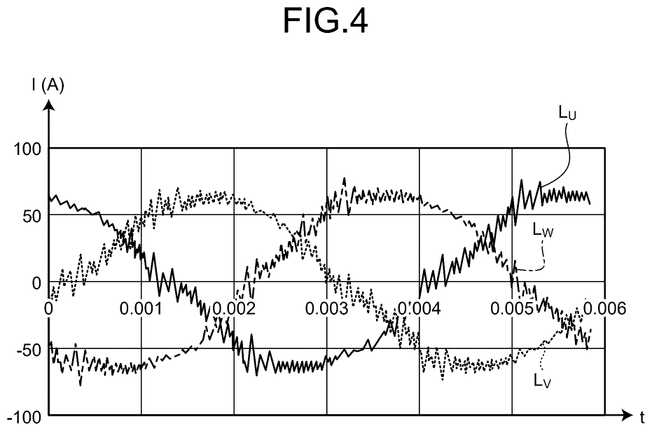

In step S103, the ECU 50 determines whether each of the current values Iu, Iv, and Iw detected by the ammeters 60 exceeds a threshold value αA. FIG. 4 is a diagram illustrating a relationship between each current value and time in each phase. In FIG. 4, the horizontal axis represents time, the vertical axis represents the current value I (A). In FIG. 4, the curve Lu indicates the current value Iu of the U-phase, the curve Lv indicates the current value Iv of the V-phase, and the curve Lw indicates the current value Iw of the W-phase. As illustrated in the curve Lu, the curve Lv and the curve Lw of FIG. 4, the ECU 50 determines whether each of the current values Iu, Iv, and Iw detected by the ammeters 60 exceeds the threshold value αA. Here, the threshold value QA is determined from the power element rating constraint of the second inverter 20. If the ECU 50 determines that each of the current values Iu, Iv, and Iw detected by the ammeters 60 exceeds the threshold αA (Yes in step S103), the process of the motor drive system 1 proceeds to step S104. In contrast, if the ECU 50 determines that each of the current values Iu, Iv, and Iw detected by the ammeters 60 does not exceed the threshold αA (No in step S103), the process of the motor drive system 1 ends.

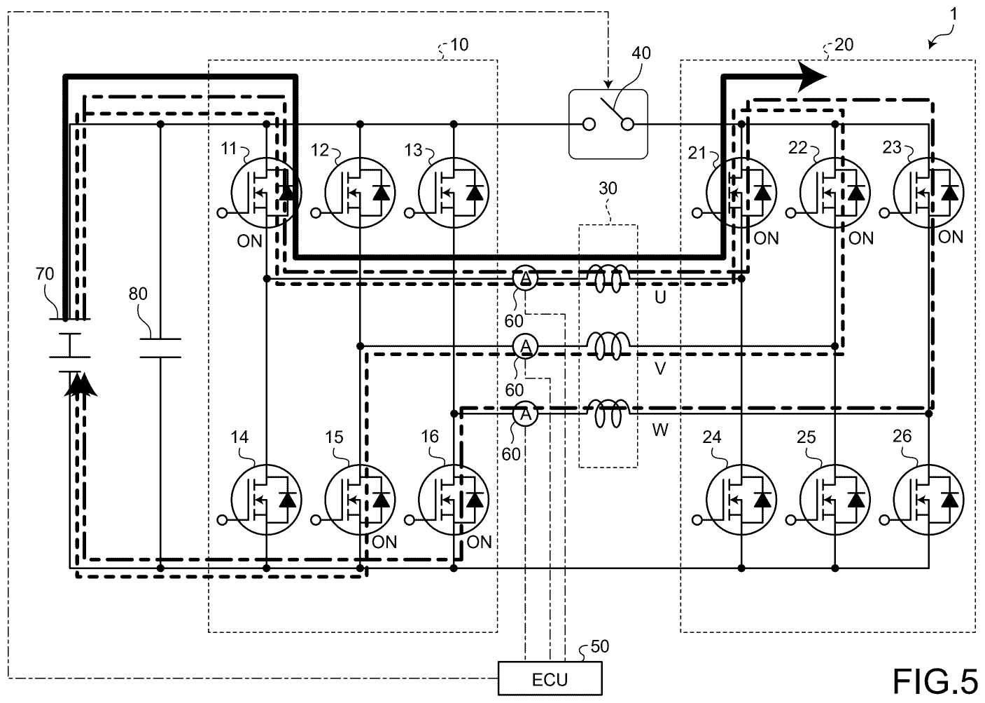

In step S104, the ECU 50 turns off the switch 40 to set to an off state (open state) to drive the first inverter 10 to set the open-winding motor 30 in a single inverter mode (step S104). FIG. 5 is a circuit schematic diagram of the motor drive system 1 in the single inverter mode. As illustrated in FIG. 5, by driving the first inverter 10 by the switch 40 to the off state (open state) to drive the open-winding motor 30 in a single inverter mode (single inverter mode drive). In this case, as illustrated in FIG. 5, the ECU 50 turns off the switch 40 to the open state and also always turns on the power elements 21, 22, and 23 of the second inverter 20. As a result, distributed currents flow through the two arms (V-phase and W-phase) other than the current concentrated phase of the first inverter 10 (U-phase) through the open winding motor 30. Thus, the motor drive system 1 can avoid current concentration to the power element 24 of the second inverter 20. Furthermore, the motor drive system 1 can simultaneously protect of the second inverter 20, reduce heat generation and reduce the motor ripple. Furthermore, since it is possible to design a small shape of the power element 24 of the second inverter 20, it is possible to optimize the cost and shape of the product. After step S104, the motor drive system 1 ends this process.

According to one embodiment described above, if the motor lock to the open winding motor 30 occurs, the ECU 50 distributes current flow the two arms other than the current concentration phase of the first inverter 10 through the open winding motor 30. Therefore, when the motor locks, since there is no need to switch the switching frequency, it is possible to reduce the surge voltage to the power element 11 of the first inverter 10 and the power element 24 of the second inverter 20.

Further, according to one embodiment, when the motor locking to the open winding motor 30 occurs, the ECU 50 drives the open winding motor 30 in a single inverter mode by driving the first inverter 10 by switching the switch 40 to the off-state (open state). Therefore, it is possible to protect the second inverter 20, reduce heat generation reduction and reduce motor ripple, simultaneously.

Further, according to one embodiment, in a case where the motor lock to the open winding motor 30 occurs, when each of the current values Iu, Iv, and Iw detected by the ammeters 60 exceeds the threshold value αA, the ECU 50 sets the switch 30 to off state (open state) to drive the first inverter 10 so that the open winding motor 30 is driven in a single inverter mode. Therefore, it is possible to design a smaller shape of the power device 24 of the second inverter 20, and it is possible to optimize the cost and shape of the product.

According to the present disclosure, when the motor locks, an effect is obtained that it is possible to reduce the surge voltage to the switching elements.

### OTHER EMBODIMENTS

Further effects and variations can be readily derived by one skilled in the art. The broader aspects of the disclosure are not limited to the specific details and representative embodiments expressed and described above. Accordingly, various changes may be made without departing from the spirit or scope of the overall inventive concept defined by the appended claims and their equivalents.

While some of the embodiments of the present application have been described in detail based on the drawings, these are illustrative, and it is possible to implement the present disclosure in other forms which are variously modified and improved based on the knowledge of those skilled in the art, starting from the aspects described in the column of the disclosure of the present disclosure.

Although the disclosure has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A motor drive system comprising:
a motor;
a first inverter including a plurality of switching elements corresponding to windings of the motor,
a second inverter including a plurality of switching elements corresponding to the windings of the motor, a current capacity of the second inverter being less than a current capacity of the first inverter; and
a processor for controlling the first inverter and the second inverter, wherein
the processor is configured to, when a motor lock occurs to the motor, distribute current to two arms other than a current concentrated phase of the first inverter through the motor.

2. The motor drive system according to claim 1, further comprising a switch for electrically connecting between the first inverter to the second inverter, wherein
the processor is configured to, when a high torque is requested to the motor, set the switch to an ON state to drive the motor with the first inverter to the second inverter, and
the processor is further configured to, when a motor lock occurs to the motor, set the switch to an OFF state and distribute current to two arms other than the current concentrated phase of the first inverter through the motor.

3. The motor drive system according to claim 2, further comprising ammeters for detecting current values of currents flowing the windings of the motor, wherein
the processor is configured to, in a case where the motor lock occurs to the motor and when each of the current values of the currents flowing though the windings of the motor detected by the ammeters exceeds a threshold value, set the switch to the OFF state and distribute current to two arms other than the current concentrated phase of the first inverter through the motor.
